(19) United States
(12) Patent Application Publication
(10) Pub. No.: US 2025/0178083 A1
(43) Pub. Date: Jun. 5, 2025

(54) ALLOY POWDER, METHOD FOR MANUFACTURING A PART BASED ON SAID ALLOY AND RESULTING PART

(71) Applicants: Safran Aircraft Engines, PARIS (FR); SAFRAN, PARIS (FR); ALLIANCE, SAINT VIT (FR)

(72) Inventors: Hugo Jean-Louis SISTACH, MOISSY-CRAMAYEL (FR); Sébastien Jean RICHARD, MOISSY-CRAMAYEL (FR); Cédric Pierre Jacques COLAS, MOISSY-CRAMAYEL (FR); Romaric Jean-Marie PIETTE, MOISSY-CRAMAYEL (FR); Jean-Claude BIHR, SAINT VIT (FR); Clément GILLOT, Plumont (FR)

(73) Assignees: Safran Aircraft Engines, PARIS (FR); SAFRAN, PARIS (FR); ALLIANCE, SAINT VIT (FR)

(21) Appl. No.: 18/840,327

(22) PCT Filed: Feb. 20, 2023
(86) PCT No.: PCT/FR2023/050233

§ 371 Date: Aug. 21, 2024

(30) Foreign Application Priority Data
Feb. 22, 2022 (FR) FR2201544

(51) Int. Cl. B22F 1/10; B22F 3/22; B22F 3/24

(52) U.S. Cl. CPC B22F 1/10; B22F 3/225; B22F 3/24; B22F 2003/241; B22F 2003/248; B22F 2201/02; B22F 2301/15; B22F 2303/01; B22F 2304/15

(57) ABSTRACT

The invention relates to a nickel-based alloy powder, that comprises in weight percentages, 14.00 to 15.25% of chromium, 14.25 to 15.75% of cobalt, 4.00 to 4.60% of aluminium, 0 to 0.50% of iron, 0 to 0.15% of manganese, 3.00 to 3.70% of titanium, 3.90 to 4.50% of molybdenum, 0 to 0.015% of sulphur, 0 to 0.06% of zirconium, 0.012 to 0.020% of boron, 0 to 0.20% of silicon, 0 to 0.10% of copper, 0 to 150 ppm of carbon, 0 to 0.5 ppm of bismuth, 0 to 5 ppm of lead, 0 to 1000 ppm of platinum, 0 to 1000 ppm of palladium, 0 to 50 ppm of hydrogen, 0 to 5 ppm of silver, 0 to 120 ppm of nitrogen, 0 to 1000 ppm of rhenium, 0 to 410 ppm of oxygen and 0 to 500 ppm of inevitable impurities, the rest being made up of nickel, and has a particle size D10 between 3 and 10 μm, a particle size D90 between 20 and 40 μm and a particle size D50 between 10 and 20 μm, the values of the particle sizes D10, D50 and D90 having been measured by laser diffraction according to standard ISO 13322-2. The invention also relates to a method for manufacturing a part using said powder and a resulting part.

### TECHNICAL FIELD

The invention concerns a nickel-based alloy powder particularly intended for use in a metal injection molding manufacturing method.

The invention also concerns such a manufacturing method using this powder, as well as a part, especially for aeronautics, manufactured by this method.

### STATE OF THE ART

In a turbojet engine, the exhaust gases generated by the combustion chamber can reach high temperatures, greater than 1200° C. or even 1600° C. The parts of the turbojet engine in contact with these exhaust gases, such as turbine blades for example, must thus be able to retain their mechanical properties at these high temperatures.

To this end, it is known to manufacture certain parts of the turbojet engine from “superalloys”. Superalloys, typically nickel-based, are a family of high-strength metal alloys that can work at temperatures relatively close to their melting points (typically 0.7 to 0.9 times their melting points).

The René 77 intermetallic alloy produced by casting has been used in the manufacture of certain turbine parts. In fact, René 77 parts can work up to 1000° C. while undergoing high fatigue, tensile and creep stresses. René 77 parts also have very good resistance to oxidation and corrosion up to 1100° C.

However, nickel-based alloys that withstand such high temperatures, for example higher than 900° C., are often refractory materials that have a strong tendency to crack.

Metal injection molding (MIM) is also known from the state of the art. This method can advantageously be used for the manufacture of complex turbomachine parts of the desired size.

Several materials are commercially available for manufacturing turbomachine parts by the MIM method.

Nickel-based Inconel 718, for example, is commonly used, but the resulting part cannot work above 650° C., which is too low for use in the combustion chamber or at the turbine.

Hastelloy X is another available material that allows the manufacture of parts that can work up to 950° C. However, its mechanical properties are limited, and it can only be used for lightly loaded parts.

There is therefore a need to resolve the abovementioned problems.

### BRIEF DESCRIPTION OF THE INVENTION

One object of the invention is therefore to propose a solution that makes it possible to obtain complex parts, such as, for example, turbine nozzles, turbine blades with internal channels, retaining rings or watertight sections, of controlled size, made of an alloy material that has good tensile, fatigue, and creep strength and oxidation/corrosion resistance up to a minimum of 1000° C. and, in addition, can be used in a MIM casting method.

Another object of the invention is to obtain parts for aeronautics having a good surface finish.

To this end, the invention proposes a nickel-based alloy powder, characterized in that it comprises, in weight percentages, 14.00 to 15.25% chromium, 14.25 to 15.75% cobalt, 4.00 to 4.60% aluminum, 0 to 0.50% iron, 0 to 0.15% manganese, 3.00 to 3.70% titanium, 3.90 to 4.50% molybdenum, 0 to 0.015% sulfur, 0 to 0.06% zirconium, 0.012 to 0.020% boron, 0 to 0.20% silicon, 0 to 0.10% copper, 0 to 150 ppm carbon, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 120 ppm nitrogen, 0 to 1000 ppm rhenium, 0 to 410 ppm oxygen and 0 to 500 ppm unavoidable impurities, the remainder being nickel, and in that it has:
a particle size D10 comprised between 3 and 10 μm,
a particle size D90 comprised between 20 and 40 μm and,
a particle size D50 comprised between 10 and 20 μm,
   the values of the particle sizes D10, D50 and D90 having been measured by laser diffraction according to ISO standard 13322-2.

The chemical composition and particle size of the alloy powder are chosen so that the alloy powder can be used in a powder injection molding method and so as to obtain, at the end of the process, an alloy part having good tensile, fatigue, and creep strength and oxidation and corrosion resistance up to 1000° C.

The invention also proposes a method for manufacturing a part, especially for aeronautics, characterized in that it comprises the following steps:
a step of mixing the nickel-based alloy powder as described above with at least one plastic binder,
a step of granulating this mixture, in order to obtain granules of alloy and plastic mixture
a step of injection molding the mixture granules into a mold, to obtain a green part,
a debinding step to obtain a debinded part,
a step of sintering the debinded part to obtain a sintered part.

This method makes it possible to obtain, from the alloy powder described above, complex parts of controlled size and having a good surface finish.

This method also makes it possible to obtain parts with good tensile, fatigue, and creep strength and oxidation and corrosion resistance up to 1000° C., while being less massive than a part made of a nickel-based alloy.

According to other advantageous and non-limiting characteristics of the invention, taken alone or in combination:
the method also comprises a step of quenching the sintered part, which consists of a heat treatment of the sintered part at a temperature comprised between 1120° C. and 1190° C., preferably a temperature comprised between 1150° C. and 1170° C. for a period comprised between 1 hour and 3 hours, preferably for 2 hours at atmospheric pressure, this step being carried out after the sintering step,
the method also comprises a tempering heat treatment step which consists of a heat treatment of the sintered part at a temperature comprised between 720° C. and 800° C., preferably a temperature comprised between 750° C. and 770° C. for a period comprised between 3.5 hours and 4.5 hours, preferably for 4 hours, this step being carried out after the sintering step and after the optional quenching step,
the method also comprises a hot isostatic pressing step which consists of a heat treatment at a temperature comprised between 1160° C. and 1200° C., preferably a temperature of 1180° C., for 2 hours to 4 hours under a pressure of greater than 100 MPa and less than 200 MPa, preferably a pressure comprised between 110 MPa and 130 MPa, this step being carried out after the sintering step and before the optional quenching and tempering heat treatment steps,
the method also comprises a step of heat treating the sintered part at high temperature, which consists of a heat treatment of the sintered part at a temperature comprised between 1200° C. and 1280° C., preferably a temperature comprised between 1220° C. and 1240° C. for a period comprised between 2 hours and 6 hours, preferably for five hours at atmospheric pressure, this step being carried out after the sintering step and after the optional hot isostatic pressing step, but before the optional heat treatment steps,
the alloy volumetric filling ratio of the mixture of plastic and alloy granules 3 is comprised between 50% and 75% and the hot melt flow of the said granules is between 60 cm³/10 min and 85 cm³/10 min at a temperature comprised between 190° C. and 230° C., and the injection temperature during the molding step is comprised between 170° C. and 200° C., the measurement of the hot melt flow being carried out according to ISO 1133-1,
the diameter of the alloy and plastic mixture granules is comprised between 1 mm and 5 mm,
the debinding step itself comprises two successive steps: a first step of primary chemical debinding of the green part so as to obtain a partially debinded part, and a second step of thermal debinding of the partially debinded part to obtain a debinded part,
the primary debinding step is catalytic debinding under nitrogen, in the presence of nitric acid vapors, for a period comprised between 2 and 10 hours, the flow rate of the nitric acid vapors being between 2 mL/min and 5 mL/min, the temperature being comprised between 10° and 150° C.,
the primary debinding step is solvent debinding with demineralized water, with stirring of the water, the water temperature being comprised between 2° and 100° C. for a period comprised between 100 and 300 h,
the thermal debinding step is carried out under argon at a pressure comprised between 200 mbar and 500 mbar by two successive temperature stages, the first temperature stage being comprised between 450° C. and 550° C. for 150 to 300 minutes, the second temperature stage being comprised between 550° C. and 650° C. for 150 to 300 minutes,
the step of sintering the debinded part is carried out by applying a temperature comprised between 126° and 1300° C. for a period comprised between 4 and 8 hours under an argon atmosphere at a pressure comprised between 20 mbar and 50 mbar.

Finally, the invention relates to a nickel-based alloy part, especially for aeronautics, characterized in that it is manufactured by the manufacturing method as described above.

According to other advantageous and non-limiting characteristics of the invention, taken alone or in combination:
the part comprises, in weight percentages, 14.00 to 15.25% chromium, 14.25 to 15.75% cobalt, 4.00 to 4.60% aluminum, 0 to 0.50% iron, 0 to 0.150% manganese, 3.00 to 3.70% titanium, 3.90 to 4.50% molybdenum, 0 to 0.015% sulfur, 0 to 0.060% zirconium, 0.012 to 0.020% boron, 0 to 0.20% silicon, 0 to 0.100% copper, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 200 ppm nitrogen, 0 to 1000 ppm rhenium, 250 to 900 ppm carbon, 0 to 500 ppm oxygen and 0 to 500 ppm unavoidable impurities, the remainder being nickel and in that it also has a microstructure with metallurgical grains comprised between ASTM 00 and ASTM 9, the measurement of the size of the metallurgical grains being carried out according to ASTM E112,
the part is a turbine blade, a turbine nozzle, a retaining ring, a watertight section or a trim part.

### BRIEF DESCRIPTION OF THE FIGURES

Other characteristics and advantages of the invention will result from the detailed description which follows, with reference to the attached drawings, in which:

FIG. 1 shows an electron microscope view of a René 77 part produced by casting after a series of heat treatments.

FIG. 2 schematically shows the various steps of the manufacturing method according to the invention.

FIGS. 3A and 3B respectively show two optical microscope views, at two different scales, of a part obtained at the end of the sintering step of the manufacturing method according to the invention.

FIGS. 4A and 4B show two optical microscope views, at two different scales, of a part obtained at the end of the hot isostatic pressing (HIP) step of the manufacturing method according to the invention, said hot isostatic pressing step having been carried out after the sintering step.

FIGS. 5A and 5B show two optical microscope views, at two different scales, of a part obtained at the end of the high temperature heat treatment step of the manufacturing method according to the invention, said high temperature heat treatment step having been carried out after the hot isostatic pressing (HIP) step.

### DETAILED DESCRIPTION OF EMBODIMENTS

The René 77 alloy produced by casting comprises, in weight percentages, between 0.05% and 0.09% carbon, between 14.25% and 15.75% cobalt, between 14.00% and 15.25% chromium, between 4.00% and 4.60% aluminum, between 3.90% and 4.50% molybdenum, between 3.00% and 3.70% titanium, less than 0.50% iron, between 0.012% and 0.020% boron, between 0 and 0.06% zirconium, between 0 and 0.15% manganese, between 0 and 0.20% silicon, between 0 and 0.10% copper, between 0 and 0.015% sulfur, less than 0.5 ppm bismuth, less than 5 ppm silver, less than 5 ppm lead, less than 25 ppm nitrogen, less than 1000 ppm platinum, less than 1000 ppm rhenium and less than 1000 ppm palladium, the remainder being the nickel that is the base of the alloy and unavoidable impurities.

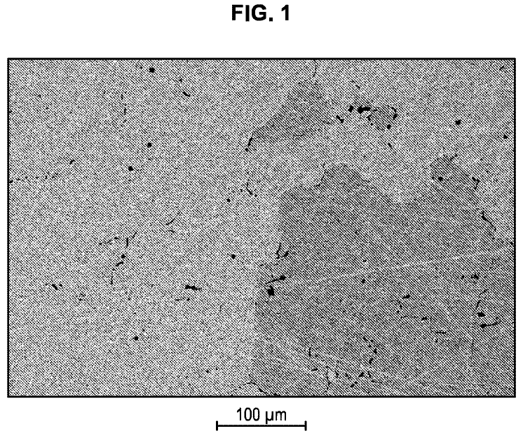

The microstructure of René 77 produced by casting has metallurgical grains whose size is less than or equal to ASTM 00. FIG. 1 is a representation of such a René 77 microstructure produced by casting in which the grains measure ASTM 00. At the bottom left of FIG. 1, one of the said metallurgical grains can be distinguished in darker gray. The measurement of the size of the metallurgical grains is carried out according to ASTM standard E112.

The René 77 intermetallic alloy has interesting mechanical and chemical properties for applications in the field of turbomachines. In fact, René 77 parts produced by casting maintain good mechanical, creep, fatigue and tensile strength up to 1000° C., as well as good corrosion and oxidation resistance up to 1100° C. By way of example, for temperatures below 800° C., the limit stress leading to tensile failure Rₘ of René 77 parts produced by casting is greater than 650 MPa. Over the same temperature range, the elastic limit with 0.2% residual plastic deformation of said parts Rp_{p 0.2} is reached for a stress greater than 500 MPa and the elongation at break is greater than 2%.

On the other hand, metal powder injection molding makes it possible to obtain parts of complex shape with an excellent surface finish and to finely control the dimensions of said parts. Metal powder injection molding is also a method which is distinguished by its speed of implementation.

The invention relates to an alloy powder and to a method, the parameters of which have been chosen to obtain, from the alloy powder and at the end of the process, parts that advantageously combine the properties of a René 77 alloy part and those of a part resulting from a metal powder injection molding method.

The MIM method is a method of molding parts by injecting a mixture of metal powder and plastic binder into a mold. The strength of the injected part is ensured by the plastic binder. The plastic binder is removed in subsequent steps, called debinding steps. The debinded part is fragile, because it is very porous. An additional sintering step is necessary during which the particles of metal powder are bonded together.

### Nickel Alloy Powder for Use in Metal Powder Injection Molding

The invention relates to a nickel-based metal alloy powder. The chemical composition and particle size of the alloy powder have been chosen to allow its use in a metal injection molding (MIM) method and to obtain, at the end of the process, a nickel-based alloy part whose chemical composition and mechanical properties are close to those of the René 77 alloy from casting.

### Chemical Composition of the Powder

Although the plastic binder is almost completely removed during the debinding steps described above, residues of this plastic binder impregnate the metallic material. Nitrogen, oxygen and carbon levels are higher in the molded part produced by the powder injection molding method than in the powder injected at the beginning of the process.

However, the carbon, nitrogen and oxygen levels given in the Rene 77 specification are relatively low compared to the expected mechanical properties. A high carbon content, for example, leads to the formation of carbides at grain boundaries which block the growth and movement of said grains. The part is then less ductile and may break during use. High levels of oxygen and nitrogen also lead to a decrease in the ductility of the part and rapid breakage under fatigue and tensile stress.

The contents of the various elements of the alloy powder of the invention, in particular the contents of nitrogen, oxygen and carbon, were therefore chosen accordingly.

The alloy powder according to the invention comprises, in weight percentages, 14.00 to 15.25% chromium, 14.25 to 15.75% cobalt, 4.00 to 4.60% aluminum, 0 to 0.50% iron, 0 to 0.15% manganese, 3.00 to 3.70% titanium, 3.90 to 4.50% molybdenum, 0 to 0.015% sulfur, 0 to 0.06% zirconium, 0.012 to 0.020% boron, 0 to 0.20% silicon, 0 to 0.10% copper, 0 to 150 ppm carbon, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 120 ppm nitrogen, 0 to 1000 ppm rhenium, 0 to 410 ppm oxygen and 0 to 500 ppm unavoidable impurities, the remainder being nickel.

“Unavoidable impurities” are defined as elements that are not intentionally added to the composition of the powder and that are provided by other elements. By way of unavoidable impurities, mention may be made, for example, of yttrium, which may come from the crucibles used for atomizing the powder.

The alloy powder according to the invention comprises, in weight percentages, between 0 and 50 ppm of each element considered as constituting an unavoidable impurity.

### Particle Size of the Powder

The particle size of the powder has been chosen so that the powder can be used in the manufacturing method described below, especially during the injection and sintering steps.

The implementation of the powder injection molding method requires a control of the powder particle size to ensure a good injection of the alloy powder and plastic binder mixture into the mold of the part. In fact, small alloy powder particles induce a large contact interface between the alloy powder and the plastic binder within the alloy powder/plastic binder mixture and therefore high friction during injection of said mixture into the mold of the part. Conversely, particles of alloy powder that are too large are more difficult to carry by the plastic binder during said injection and can therefore lead to a non-homogeneous injected part.

In addition, the particle size is important to obtain good sintering, a step during which the particles will diffuse and bind to each other so as to eliminate their interfaces and thus lower their entropy. Fine powder will thus be more easily sinterable because by grouping, the small powder particles will reduce their interfaces and their surfaces more strongly, causing their entropy to drop significantly.

The particle size of the alloy powder of the invention has therefore been defined by a range of acceptable values for the particle sizes D10, D50 and D90 of said alloy powder.

The particle size D10 corresponds to 10% passing. In other words, 10% by number of the particles of the alloy powder have a diameter less than D10. Likewise, the particle sizes D50 and D90 respectively correspond to 50% and 90% passing.

The particle size D10 of the alloy powder according to the invention is comprised between 3 and 10 μm. The particle size D50 is comprised between 10 and 20 μm. Finally, the particle size D90 is comprised between 20 and 40 μm.

The values of the particle sizes D10, D50 and D90 were measured according to ISO standard 13322-2. This standard provides for measurement by laser diffraction.

### Powder Preparation

The nickel-based alloy powder that is the subject of the invention can, for example, be obtained from René 77 alloy basic elements by a powder atomization method. The atomization method provides the chemical composition and particle size of the alloy powder obtained. In addition, it ensures a good morphology of the powder, mainly spherical. Finally, it makes it possible to limit the risks of contamination.

### Metal Powder Injection Molding Method

The invention also relates to a method for manufacturing a part, especially for aeronautics, which uses the nickel-based alloy powder defined above.

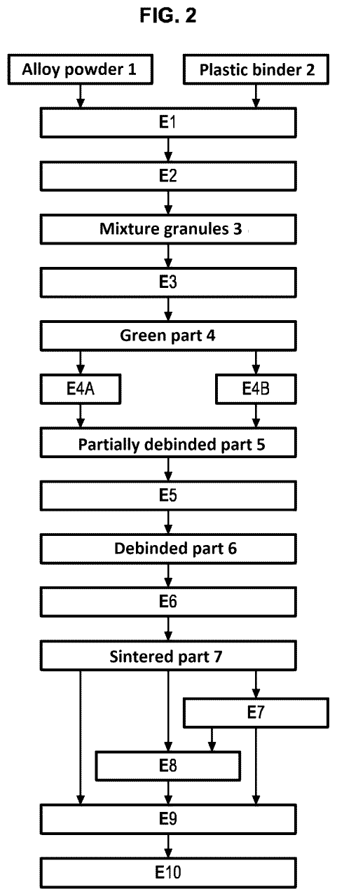

In general, this method includes successive steps of mixing, granulation, injection molding, chemical debinding, thermal debinding, sintering and quenching. Optionally, the method can also comprise one or more additional heat treatment steps. These steps are described in greater detail below with reference to FIG. 2.

### Mixing.

In a first mixing step E1, the nickel-based alloy powder 1 according to the invention is mixed with at least one plastic binder 2, preferably two plastic binders. This binder 2 is, for example, polyethylene (PE) or polyethylene glycol (PEG) or a mixture of the two. During mixing step E1, the temperature is set at a value such that the plastic is pasty to allow good mixing. The temperature depends on the composition of the plastic; it is for example comprised between 50° C. and 150° C. During mixing step E1, the titanium-based alloy powder 1 and the plastic binder 2 are mixed in proportions chosen so as to obtain, at the end of granulation step E2 described below, the mixture of plastic and alloy granules 3 having a hot melt flow guaranteeing an efficient injection of the said granules 3 during the molding step E3. The mixture of alloy powder 1 and at least one plastic binder 2 preferably comprises, in percentage by volume, between 50% and 75% of alloy powder 1 and between 50% and 25% of plastic binder 2, so that the granules of mixture 3 have a hot melt flow comprised between 60 cm³/10 min and 85 cm³/10 min at a temperature comprised between 190° C. and 230° C., the hot melt flow being measured according to ISO standard 1133-1.

### Granulation.

In a second step E2 of granulating the mixture of alloy powder and at least one plastic binder, the mixture from step E1 is passed through an extruder to obtain the mixture of plastic and alloy granules 3, known to the person skilled in the art as feedstock. The shape and size of the mixture of plastic and alloy granules 3 are fixed by the extruder settings. The mixture of plastic and alloy granules 3 are, for example, cylinders whose base diameter is preferably comprised between 1 mm and 5 mm.

### Molding.

In a third molding step E3, the mixture of plastic and alloy granules 3 are injected into the mold of the part to be manufactured, the injection temperature being comprised between 17° and 200° C. Below 170° C., the mixture is too solid and does not go into the mold. Above 200° C., the mixture is too liquid, the alloy powder and the plastic binder separate, and the alloy powder is not carried. Other parameters, such as injection speed, injection pressure, holding time after injection or injection time depend on the part to be injected.

Following the molding step E3, a green part 4 is obtained, which is a part of mixed alloy powder and plastic (alloy particles suspended in the plastic). Adjusting the molding parameters makes it possible to obtain a part without porosities. The plastic binder ensures the strength of the part.

### Debinding.

Debinding makes it possible to remove the plastic binder from the green part 4 obtained previously.

Two debinding steps are successively carried out, one chemical, the other thermal.

### Primary Debinding.

The primary debinding step E4 is a debinding of a chemical nature. The primary debinding step E4 makes it possible to obtain a partially debinded part 5.

This debinding can be either of the following: A debinding step E4B using a solvent, or preferably a catalytic debinding step E4A. The latter has the advantage of being faster.

Catalytic debinding step E4A consists of vaporizing and then burning the plastic binder by injecting acid vapors in a furnace.

Catalytic debinding is carried out, for example, at a temperature comprised between 100° C. and 150° C. for 2 to 10 hours, under a nitrogen atmosphere, in the presence of nitric acid vapors, the nitric acid flow preferably being comprised between 2 and 5 mL/min.

Debinding step E4B using a solvent consists of bathing the green part 4 in a bath of said solvent, so as to dissolve the plastic.

Debinding step E4B is, for example, debinding with water, the green part 4 being immersed for 100 to 300 hours in a bath of demineralized water with stirring at a temperature comprised between 2° and 100° C., preferably around 60° C.

At the end of the chemical debinding step E4, the partially debinded part 5 is obtained, the chemical debinding having made it possible to remove more than 95% of the plastic binder.

### Thermal Debinding.

Thermal debinding step E5 is preferably carried out under an argon atmosphere at a pressure comprised between 200 mbar and 500 mbar by the successive application of two temperature stages to the partially debinded part 5. During the first stage, a temperature comprised between 450° C. and 550° C. is applied for 150 minutes to 300 minutes. During the second stage, a temperature comprised between 550° C. and 650° C. is applied for 150 minutes to 300 minutes.

At the end of the thermal debinding step (E5), a debinded part or “brown part” 6 is obtained, the thermal debinding having made it possible to remove the remaining plastic binder (i.e. the remaining less than 5%).

The debinded part 6 resulting from the primary debinding step E4 and the thermal debinding step E5 is a part of the same dimensions as the green part 4. However, unlike the green part 4, the debinded part 6 is very porous because the plastic binder has been removed, the density of the debinded part 6 is comprised between 50% and 75% of the density of a René 77 alloy part produced by casting. In addition, the debinded part 6 is very fragile because the plastic binder which ensured the strength of the part has been removed.

### Sintering.

During step E6, the debinded part 6 is sintered. Sintering consists of subjecting the debinded part 6 to a temperature close to the melting point of the alloy powder so that the powder particles bind together. During sintering, the part shrinks, and its density increases.

Sintering is carried out in a furnace, preferably at a temperature comprised between 126° and 1300° C. for 4 hours to 6 hours under an argon atmosphere at a pressure comprised between 20 mbar and 50 mbar.

Preferably, the thermal debinding step E5 and the sintering step E6 are carried out in the same furnace, since the debinded part 6 is fragile.

At the end of the sintering step E6, a more compact sintered part 7 is obtained, the density of which is preferably greater than 95% of the density of a conventional René 77 alloy from casting. The dimensions of the sintered part 7 are smaller than those of the debinded part or brown part 6. Typically, a reduction in size comprised between 14 and 18% is observed.

The sintered nickel-based alloy 7 part comprises, in weight percentages, 14.00 to 15.25% chromium, 14.25 to 15.75% cobalt, 4.00 to 4.60% aluminum, 0 to 0.50% iron, 0 to 0.150% manganese, 3.00 to 3.70% titanium, 3.90 to 4.50% molybdenum, 0 to 0.015% sulfur, 0 to 0.060% zirconium, 0.012 to 0.020% boron, 0 to 0.20% silicon, 0 to 0.100% copper, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 200 ppm nitrogen, 0 to 1000 ppm rhenium, 250 to 900 ppm carbon, 0 to 500 ppm oxygen and 0 to 500 ppm unavoidable impurities, the remainder being nickel. In particular, the sintered nickel-based alloy part 7 comprises, in weight percentages, between 0 and 50 ppm of each element considered as constituting an unavoidable impurity.

The chemical composition of the sintered part 7 is very close to that of the initial alloy powder. Only carbon, oxygen and nitrogen levels increase significantly during the MIM process. By way of example, if the alloy powder 1 comprises 250 ppm of oxygen, 20 ppm of nitrogen and 700 ppm of carbon, the sintered part 7 obtained by the method according to the invention from the alloy powder 1 comprises 270 ppm of oxygen, 100 ppm of nitrogen and 1100 ppm of carbon.

The additional carbon, oxygen and nitrogen elements are residues of the plastic binder that impregnated the metallic material. However, a proportion of said elements that is too high can have a negative impact on the mechanical properties of the alloy part resulting from the MIM method. Alloy powder 1 must have much lower carbon, oxygen and nitrogen levels than those of the Rene 77 targeted.

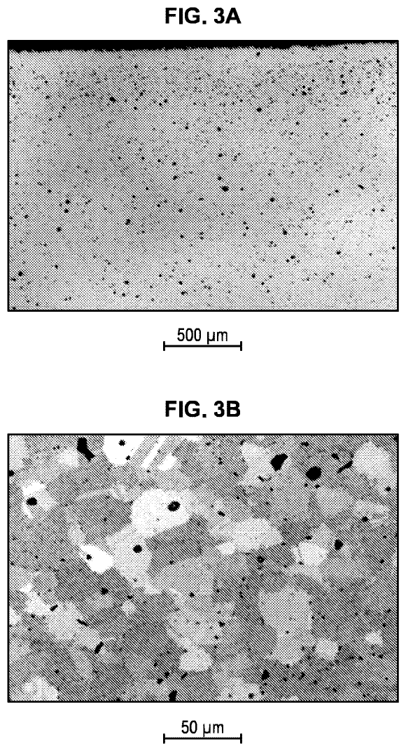

FIGS. 3A and 3B show two optical microscope views, at two different scales, of a sintered part 7 obtained at the end of the sintering step of the method according to the invention. In FIG. 3A and FIG. 3B recorded after chemical etching to improve the phase contrast, a characteristic microstructure of a nickel-based alloy is observed. The metallurgical grains, which appear as gray areas whose contrast varies from one grain to another, are bound and the material is relatively dense. However, the material also includes porosity residues (note the small round and black spots) that can affect the mechanical properties of the final part. Heat treatments, for example hot isostatic pressing, can be used to eliminate said porosity residues.

In addition, the size of the metallurgical grains within the sintered part 7 is relatively small, comprised between ASTM 5 and ASTM 9. The metallurgical grains are measured according to ASTM standard E112. By way of example, the size of the grains of the microstructure in FIGS. 3A and 3B is ASTM 6. A part composed of small metallurgical grains has good fatigue resistance but poor creep resistance. Depending on the intended application of the manufactured part, a high temperature heat treatment can be implemented to increase the size of the metallurgical grains of the said part. The conditions of said treatment are chosen to guarantee fatigue, creep and tensile properties in accordance with the intended application.

### Hot Isostatic Pressing.

Optionally, a hot isostatic pressing step E7 of the sintered part 7 can be implemented in order to fill in the residual porosities, especially if the density of the sintered part is less than 95% of the density of the René 77 alloy from casting. The hot isostatic pressing step E7 makes it possible to increase the density of the part 7 resulting from the sintering up to 100% of the density of René 77 from casting and to improve the mechanical properties of said part. In addition, the hot isostatic pressing step reduces the dimensional dispersion of parts produced by the metal powder injection molding method.

During hot isostatic pressing step E7, high pressure and temperature are applied together in an inert atmosphere. For example, a temperature comprised between 1160° C. and 1200° C., preferably a temperature of 1180° C., and a pressure of greater than 100 MPa and less than 200 MPa, preferably comprised between 110 MPa and 130 MPa, are applied for 2 hours to 4 hours under an inert atmosphere, for example a helium atmosphere or vacuum, preferably an argon atmosphere.

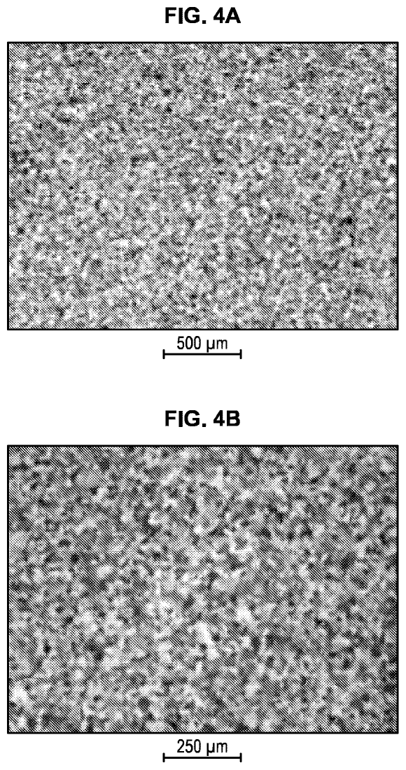

FIGS. 4A and 4B are two optical microscope views, at two different scales, of a part obtained at the end of steps E6 and E7 of the method according to the invention. The microstructure of the nickel alloy is recognizable, but spots are no longer distinguished. Step E7 of hot isostatic pressing therefore made it possible to plug the last porosities and obtain a completely healthy material.

### High Temperature Heat Treatment

Optionally, a step E8 of heat treatment of the sintered part at high temperature may be implemented. If a hot isostatic pressing step E7 is implemented, the high temperature heat treatment step E8 is preferably carried out after said step E7.

The high-temperature heat treatment E8 consists of heating the part to a sufficiently high temperature to cause the metallurgical grains to enlarge. In fact, under the action of temperature, the grains will group together so as to limit their interface and thus lower their potential energy. Grouping of the initial metallurgical grains results in larger metallurgical grains. Temperature is a kinetic factor: The application of a high temperature increases the speed of grain grouping.

The high temperature heat treatment step E8 is advantageously implemented for the manufacture of parts which will be subjected to high creep stresses such as, for example, turbine blades and turbine nozzles. Indeed, the larger the metallurgical grains, the easier the sliding between said grains under the effect of creep stresses and therefore the better the resistance of the part to said stresses.

High temperature heat treatment step E8 preferably comprises the application of a temperature comprised between 1200° C. and 1280° C., more preferably a temperature comprised between 1220° C. and 1240° C. for a period comprised between 2 hours and 6 hours, more preferably for 5 hours at atmospheric pressure, under an inert atmosphere, for example an argon atmosphere.

After carrying out said step E8 under the conditions thus described, the size of the metallurgical grains is comprised between ASTM 00 and ASTM 5, on average it is ASTM 2.

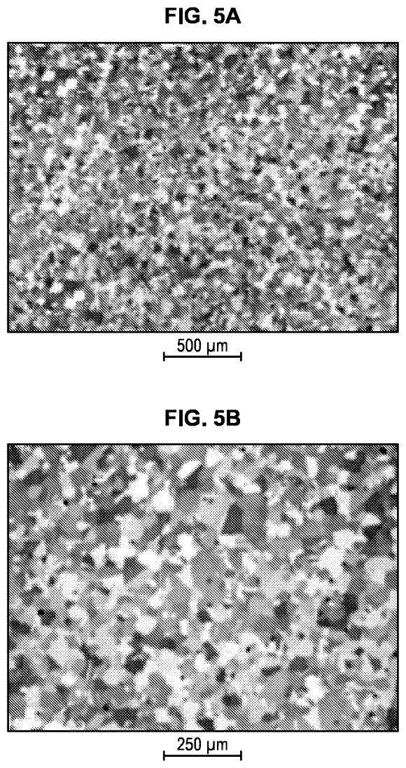

As mentioned above, the grain size was comprised between ASTM 5 and ASTM 9 at the end of sintering step E6. The grain size has therefore increased. FIGS. 5A and 5B are two light microscope views, at two different scales, of a part obtained at the end of steps E6, E7 and then E8 of the method according to the invention. Comparing the microstructure in FIGS. 5A and 5B to the microstructure in FIGS. 4A and 4B of the part after step E7 and before step E8 of the said method, it can be seen that the grain size has actually increased during the high temperature heat treatment step E8. By way of example, the size of the grains of the microstructure represented in FIGS. 4A and 4B is ASTM 2.

Increasing the grain size during step E8 improves the creep strength of the part, while guaranteeing the part good fatigue and tensile strength.

### Quenching.

In addition, a quenching heat treatment step E9 is carried out. The quenching heat treatment consists of heating the part to a temperature at which the good alloy elements, which constitute nickel, are dissolved for a sufficient period of time to allow the said elements to be re-dissolved and to diffuse into the crystalline solid. The part is then cooled relatively quickly so that said good alloy elements reprecipitate. This step makes it possible to obtain a part with the expected mechanical and chemical properties.

The quenching heat treatment step E9 is preferably carried out at a temperature comprised between 1120° C. and 1190° C., more preferably at a temperature comprised between 1150° C. and 1170° C. for a period comprised between 1 hour and 3 hours, more preferably for 2 hours. The part is finally cooled at an average rate comprised between 47° C./hour and 67° C./hour until it reaches a temperature comprised between 1070° C. and 1090° C., preferably a temperature of 1080° C., then at an average rate of greater than or equal to 16° C./min.

Throughout the quenching heat treatment step E9, which comprises heating and then cooling the part, an inert atmosphere, for example an argon atmosphere, is maintained at atmospheric pressure, or the said step is carried out under vacuum.

### Tempering Heat Treatment

Finally, a tempering heat treatment step E10 is carried out. During the tempering heat treatment E10, some alloy elements precipitate at the grain boundaries. The tempering heat treatment E10 makes it possible to obtain the expected mechanical properties for the manufactured alloy part. The treatment E10 especially makes it possible to improve the tensile strength of said manufactured part.

The tempering heat treatment step E10 comprises the application of a temperature comprised between 720° C. and 800° C., preferably between 750° C. and 770° C., for a period comprised between 3.5 h and 4.5 h, preferably a period of 4 hours in air. By way of example, under such conditions of execution of the tempering heat treatment E10, an improvement of 20% in the stress strength can be observed.

### Parts Obtained by the Method

The invention also relates to parts obtained from the manufacturing method using the alloy powder 1 according to the invention.

The said parts are nickel-based alloy parts especially comprising, in weight percentages, between 250 ppm and 900 ppm carbon, less than 200 ppm nitrogen and less than 500 ppm oxygen, the chemical compositions being measured by elemental analysis, for example by inductively coupled plasma spectrometry.

In FIG. 1, which shows a part made of René 77 produced by casting, it can be seen, as stated above, that the latter has a microstructure with grains of size ASTM 00. If the size of the metallurgical grains of a René 77 alloy produced by casting is less than or equal to ASTM 00, the size of the metallurgical grains of a part obtained from the manufacturing method using alloy powder 1 according to the invention is comprised between ASTM 00 and ASTM 9. For example, for the part obtained at the end of the sintering step E6 and whose microstructure is visible in FIGS. 3A and 3B, said grain size is 6 ASTM. For the part obtained at the end of the high temperature heat treatment step E8 of FIGS. 5A and 5B, it is ASTM 2. The parts obtained from the manufacturing method using the alloy powder according to the invention therefore have a microstructure with metallurgical grains smaller than the grains within the René 77 alloy from casting; this gives them better tensile strength and fatigue resistance than a René 77 part produced by casting.

Rₘ is the value of the limit stress leading to tensile failure Rₘ, Rp_{0.2} the value of the stress at which the elastic limit is reached with 0.2% residual plastic deformation and A % the value of the elongation at break. The Rₘ, Rp_{0.2} and A % values of a part manufactured according to the method using alloy powder 1 according to the invention, said method comprising steps E1 to E7 then E9 and E10 as described above, increase by about 30% compared to the Rₘ, Rp_{0.2} and A % values of a René 77 part produced by casting. In addition, the fatigue gain is around 20%.

The Rₘ, Rp_{0.2} and A % values of a part manufactured according to the method using alloy powder 1 according to the invention, said method further comprising a step E8 as described above, is around 15% compared to a René 77 part produced by casting. In this case, the fatigue gain is around 10%.

The invention finds a particular application in the manufacture of parts for aeronautics, such as for example turbine blades, including blades with internal channels, turbine nozzles, retaining rings, watertight sections or trim parts that are subject to high tensile, fatigue and creep stresses, that must resist corrosion and oxidation, and that are used at high temperatures above 1000° C.

1. A nickel-based alloy powder comprising, in weight percentages, 14.00 to 15.25% chromium, 14.25 to 15.75% cobalt, 4.00 to 4.60% aluminum, 0 to 0.50% iron, 0 to 0.15% manganese, 3.00 to 3.70% titanium, 3.90 to 4.50% molybdenum, 0 to 0.015% sulfur, 0 to 0.06% zirconium, 0.012 to 0.020% boron, 0 to 0.20% silicon, 0 to 0.10% copper, 0 to 150 ppm carbon, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 120 ppm nitrogen, 0 to 1000 ppm rhenium, 0 to 410 ppm oxygen and 0 to 500 ppm unavoidable impurities, the remainder being nickel,
wherein the nickel-based alloy powder has:
a particle size D10 comprised between 3 and 10 μm,
a particle size D90 comprised between 20 and 40 μm and,
a particle size D50 comprised between 10 and 20 μm,
the values of the particle sizes D10, D50 and D90 having been measured by laser diffraction according to ISO standard 13322-2.

2. A method for manufacturing a part comprising the following steps:
a step of mixing the nickel-based alloy powder according to claim 1 with at least one plastic binder, to obtain a mixture,
a step of granulating the mixture, in order to obtain granules of alloy and plastic mixture,
a step of injection molding the granules of alloy and plastic mixture into a mold, to obtain a green part (4),
a step of debinding the green part, to obtain a debinded part,
a step of sintering the debinded part, to obtain a sintered part.

3. The method according to claim 2, further comprising a step of quenching the sintered part (7), which consists of a heat treatment of the sintered part at a temperature comprised between 1120° C. and 1190° C. for a period comprised between 1 hour and 3 hours.

4. The method according to claim 2, further comprising a tempering heat treatment step which consists of a heat treatment of the sintered part at a temperature comprised between 720° C. and 800° C. for a period comprised between 3.5 hours and 4.5 hours.

5. The method according to claim 2, further comprising a hot isostatic pressing step which consists of a heat treatment of the sintered part at a temperature comprised between 1160° C. and 1200° C. for 2 hours to 4 hours under a pressure of greater than 100 MPa and less than 200 MPa.

6. The method according to claim 2, further comprising a step of heat treating the sintered part at high temperature, which consists of a heat treatment of the sintered part (7) at a temperature comprised between 1200° C. and 1280° C. for a period comprised between 2 hours and 6 hours.

7. The method according to claim 2, wherein an alloy volumetric filling ratio of the granules of alloy and plastic mixture is comprised between 50% and 75%, wherein and an hot flow melt of said granules is comprised between 60 cm³/10 min and 85 cm³/10 min at a temperature comprised between 190° C. and 230° C., and wherein an injection temperature during the step of injection molding is comprised between 170° C. and 200° C., the measurement of the hot melt flow being carried out according to ISO 1133-1.

8. The method according to claim 2, wherein a diameter of the granules of alloy and plastic mixture is between 1 mm and 5 mm.

9. The method according to claim 2, wherein the step of debinding comprises a chemical debinding of the green part (4) so as to obtain a partially debinded part (5), followed by a thermal debinding of the partially debinded part (5) to obtain a debinded part.

10. The method according to claim 9, wherein the chemical debinding is catalytic debinding under nitrogen, in the presence of nitric acid vapors, for a period comprised between 2 and 10 hours, the flow rate of the nitric acid vapors being between 2 mL/min and 5 mL/min, the temperature being comprised between 10° and 150° C.

11. The method according to claim 9, wherein the chemical debinding is solvent debinding with demineralized water (E4B), with stirring of the water, the water temperature being comprised between 2° and 100° C. for a period comprised between 100 and 300 h.

12. The method according to claim 9, wherein the thermal debinding is carried out under argon at a pressure comprised between 200 mbar and 500 mbar by two successive temperature stages, the first temperature stage being comprised between 450° C. and 550° C. for 150 to 300 minutes, the second temperature stage being comprised between 550° C. and 650° C. for 150 to 300 minutes.

13. The method according to claim 2, wherein the step of sintering the debinded part is carried out by applying a temperature comprised between 126° and 1300° C. for a period comprised between 4 and 8 hours under an argon atmosphere at a pressure comprised between 20 mbar and 50 mbar.

14. (canceled)

15. A nickel-based alloy part comprising, in weight percentages, 14.00 to 15.25% chromium, 14.25 to 15.75% cobalt, 4.00 to 4.60% aluminum, 0 to 0.50% iron, 0 to 0.150% manganese, 3.00 to 3.70% titanium, 3.90 to 4.50% molybdenum, 0 to 0.015% sulfur, 0 to 0.060% zirconium, 0.012 to 0.020% boron, 0 to 0.20% silicon, 0 to 0.100% copper, 0 to 0.5 ppm bismuth, 0 to 5 ppm lead, 0 to 1000 ppm platinum, 0 to 1000 ppm palladium, 0 to 50 ppm hydrogen, 0 to 5 ppm silver, 0 to 200 ppm nitrogen, 0 to 1000 ppm rhenium, 250 to 900 ppm carbon, 0 to 500 ppm oxygen and 0 to 500 ppm unavoidable impurities, the remainder being nickel, wherein the part further has a microstructure with metallurgical grains comprised between ASTM 00 and ASTM 9, the measurement of the size of the metallurgical grains being carried out according to ASTM E112.

16. (canceled)
